(19) United States
(12) Patent Application Publication
(10) Pub. No.: US 2024/0034269 A1
(43) Pub. Date: Feb. 1, 2024

(54) SYSTEM AND METHOD FOR DYNAMIC AUTHORIZATION, ENTITLEMENTS, AND CONDITIONAL CAPABILITIES BY OPERATIONAL CONTEXT

(71) Applicant: GM GLOBAL TECHNOLOGY OPERATIONS LLC, Detroit, MI (US)

(72) Inventors: Suresh Munagapati, Cumming, GA (US); Richard A. Range, JR., Royal Oak, MI (US); Umer Khalid, Farmington Hills, MI (US); Gwendolyn C. Melton, Dearborn, MI (US); Russell A. Patenaude, Macomb Township, MI (US)

(73) Assignee: GM GLOBAL TECHNOLOGY OPERATIONS LLC, Detroit, MI (US)

(21) Appl. No.: 17/875,689

(22) Filed: Jul. 28, 2022

(51) Int. Cl. B60R 25/01

(52) U.S. Cl. CPC B60R 25/01; B60R 2325/10

(57) ABSTRACT

A system for dynamic authorization, entitlements, and conditional capabilities by operational context to authorize operating a vehicle in conjunction with a remote cloud unit is provided. The system includes a vehicle operational system providing a functional output and a computerized controller within the vehicle. The controller includes programming to collect data from a plurality of sources related to operation of the vehicle and provide the data to a plurality of operating context analyzers to generate an operating context. The controller further includes programming to receive an authorization to operate the vehicle operational system and selectively enable operation of the vehicle operational system based upon the authorization. The system further includes the plurality of operating context analyzers determining the operating context. The system further includes the remote cloud unit, including programming to selectively generate the authorization based upon the data and the operating context and release the authorization to the controller.

### INTRODUCTION

The disclosure generally relates to a system and method for dynamic authorization, entitlements, and conditional capabilities by operational context of a vehicle with a remote assistance unit.

Security in an electronic system is important for protecting information and appropriate function of the system. Security in an electronic system within a vehicle is important to protecting function of the vehicle, occupants of the vehicle, and functions served by the vehicle. Exemplary delivery vehicles may include valuable cargo and valuable information about customers to the delivery vehicles.

### SUMMARY

A system for dynamic authorization, entitlements, and conditional capabilities by operational context to authorize operating a vehicle and integrated systems in conjunction with a remote cloud unit is provided. The system includes the vehicle. The vehicle includes a vehicle operational system providing a functional output to the vehicle and a computerized connectivity controller. The controller includes programming to collect data from a plurality of sources related to operation and state of the vehicle and associated systems and provide the data to a plurality of operating context analyzers onboard the vehicle or a remote cloud unit to generate an operating context to the data. The controller further includes programming to receive an authorization to operate the vehicle operational system and selectively enable operation of the vehicle operational system based upon the authorization. The system further includes the plurality of operating context analyzers, including programming to determine the operating context to the data based upon the data from the plurality of sources. The system further includes the remote cloud unit, including programming to selectively generate the authorization based upon the data and the operating context to the data and release the authorization to the computerized connectivity controller.

In some embodiments, the data related to operation of the vehicle includes data describing a mission selected for the vehicle, data describing other vehicles on the mission, data describing other missions, an identity of a user of the vehicle, a capability of the vehicle to accomplish the mission, an event, and an action by the user.

In some embodiments, the capability of the vehicle to accomplish the mission includes data related to a distance to be driven, geographic information, forensic print, and a configuration and state of the vehicle.

In some embodiments, the plurality of operating context analyzers are operated within the computerized connectivity controller.

In some embodiments, the remote cloud unit includes a security cloud device configured for selectively generating the authorization. The remote cloud unit further includes a vehicle services cloud configured for generating an application image including the authorization and releasing the application image to the computerized connectivity controller.

In some embodiments, the security cloud device and vehicle services cloud are segregated physically and electronically. The security cloud device and vehicle services cloud are configured for communication over a first communication network. The security cloud device and the connectivity controller are configured for communication over a second communication network distinct from the first communication network. The vehicle services cloud and the connectivity controller are configured for communication over a third communication network distinct from the first communication network and distinct from the second communication network.

In some embodiments, communication between the security cloud device and the vehicle services cloud is encrypted with a complementary pair of authorization keys.

In some embodiments, the security cloud device is further configured for determining a least required capability of the vehicle to accomplish the mission. The computerized connectivity controller selectively enabling operation of the vehicle operational system is further based upon the least required capability.

According to one alternative embodiment, a system for dynamic authorization, entitlements, and conditional capabilities by operational context to authorize operating a vehicle and integrated systems in conjunction with a remote cloud unit is provided. The system includes the vehicle. The vehicle includes a vehicle operational system providing a functional output to the vehicle and a computerized connectivity controller. The controller includes programming to collect data from a plurality of sources related to operation of the vehicle and provide the data to a plurality of operating context analyzers to generate an operating context to the data. The controller further includes programming to receive an application image including an authorization to operate the vehicle operational system and selectively enable operation of the vehicle operational system based upon the authorization. The system further includes the plurality of operating context analyzers, including programming to determine the operating context to the data based upon the data from the plurality of sources. The system further includes the remote cloud unit, including a security cloud device configured for selectively generating the authorization based upon the data and the operating context to the data. The remote cloud unit further includes and a vehicle services cloud configured for generating the application image including the authorization and releasing the application image to the computerized connectivity controller.

In some embodiments, the security cloud device and the vehicle services cloud are segregated physically and electronically. The security cloud device and vehicle services cloud are configured for communication over a first communication network. The security cloud device and the connectivity controller are configured for communication over a second communication network distinct from the first communication network. The vehicle services cloud and the connectivity controller are configured for communication over a third communication network distinct from the first communication network and distinct from the second communication network. Each of these networks may be plural and non-repetitive.

In some embodiments, communication between the security cloud device and the vehicle services cloud is encrypted with a complementary pair of authorization keys.

In some embodiments, the security cloud device is further configured for determining a least required capability of the vehicle to accomplish the mission. The computerized connectivity controller selectively enabling operation of the vehicle operational system is further based upon the least required capability.

According to one alternative embodiment, a method for dynamic authorization, entitlements, and conditional capabilities by operational context to authorize operating a vehicle and integrated systems in conjunction with a remote cloud unit is provided. The method includes operating within the vehicle a vehicle operational system providing a functional output to the vehicle. The method further includes, within a computerized processor within the vehicle, collecting data from a plurality of sources related to operation of the vehicle and providing the data to a plurality of operating context analyzers to generate an operating context to the data. The method further includes, within the computerized processor within the vehicle, receiving an authorization to operate the vehicle operational system and selectively enabling operation of the vehicle operational system based upon the authorization. The method further includes operating the plurality of operating context analyzers, including programming to determine the operating context to the data based upon the data from the plurality of sources. The method further includes, within the remote cloud unit, selectively generating the authorization based upon the data and the operating context to the data and releasing the authorization to the computerized connectivity controller.

In some embodiments, the data related to operation of the vehicle includes data describing a mission selected for the vehicle, data describing other vehicles on the mission, an identity of a user of the vehicle, a capability of the vehicle to accomplish the mission, an event, and an action by the user.

In some embodiments, the capability of the vehicle to accomplish the mission includes data related to a distance to be driven, geographic information, forensic print, and a configuration and state of the vehicle.

In some embodiments, the plurality of operating context analyzers is operated within the computerized connectivity controller.

In some embodiments, selectively generating the authorization within the remote cloud unit includes selectively generating the authorization within a security cloud device. Releasing the authorization within the remote cloud unit includes generating an application image including the authorization with a vehicle services cloud and releasing the application image to the computerized connectivity controller.

In some embodiments, the security cloud device and the vehicle services cloud are segregated physically and electronically. The method further includes communicating between the security cloud device and vehicle services cloud over a first communication network, communicating between the security cloud device and the connectivity controller over a second communication network distinct from the first communication network, and communicating between the vehicle services cloud and the connectivity controller over a third communication network distinct from the first communication network and distinct from the second communication network.

In some embodiments, the method further includes encrypting communication between the security cloud device and the vehicle services cloud with a complementary pair of authorization keys.

In some embodiments, the method further includes determining a least required capability of the vehicle to accomplish the mission. Selectively enabling operation of the vehicle operational system is further based upon the least required capability.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates a system including a plurality of devices embodied as a plurality of vehicles, in accordance with the present disclosure;

FIG. 2 schematically illustrates a flow of data in the system of FIG. 1, in accordance with the present disclosure;

FIG. 3 is a flowchart illustrating method for dynamic authorization, entitlements, and conditional capabilities by operational context, in accordance with the present disclosure; and

FIG. 4 schematically illustrates the connectivity controller of FIG. 1, in accordance with the present disclosure.

### DETAILED DESCRIPTION

Wheeled and non-wheeled vehicles are important to the functioning of the society performing functions such as carrying people, goods, equipment, and collecting data. As the vehicle travels it may pass through secure territories and territories that are not secure to the desired level. Modern vehicles are equipped with communications methods, physical and electronic devices locally or remotely to monitor the vehicle health, performance, terrain and ambience to ensure function and operational excellence of the vehicle.

The vehicle, the devices and equipment offer capabilities that can be executed by the occupants and operators and require protection and adherence to best practices and security guidelines. The characteristics of the occupants and operators, cargo, the purpose the vehicle is engaged, and the boundaries of operation form an operational context that require limiting certain capabilities with appropriate authorization and entitlements to maximize the function and user experience. The authorized and allowed set of capabilities may be grouped into modes such as a dormant mode or a connected mode etc., until an event occurs triggering change to the currently selected mode.

Disclosed herein is a system and method for dynamically authorizing the entitlements to enable or disable capabilities conditionally in relation to operational context of a vehicle and devices. Enabling a dynamic set of capabilities, entitlements and authorizations based on operational context analysis will result in the desired capabilities fit for the purpose thus improving the user experience and maximizing the function. Since the operational context includes unrestricted number and types of variables preventing the static set of capabilities, entitlements and authorizations may eliminate improper and unintended use.

The operation context analysis is performed based upon data collection or information from data collectors. These data collectors may include a wide variety of electronic and computerized sensors disposed to collect data regarding the vehicle, similar vehicles, an operational environment of the vehicle, or other similar data. The operational context analysis may include relating the vehicle to itself including state, features and devices, systems it is integrated with, events, people operating and occupying, current and other missions, other vehicles and systems participating in the same mission or other missions factoring the unrestricted set of variables such as geography, terrain, etc. The analysis may span current, historical and projected facts, perceptions, observations and evidence. Examples provided herein are intended to be non-limiting.

The system includes a connectivity module or connectivity controller installed on the vehicle and a security device adapted to enable message transmission securely when the device is within a predefined proximity of the connectivity module. A security cloud unit is configured to perform the operational context analysis in conjunction with the connectivity controller and a remote assistance vehicle services cloud unit.

A system and method for dynamic authorization, entitlements, and conditional capabilities by operational context is provided. Security including authorization, entitlements and conditional capabilities may be utilized to protect proper function of a vehicle. They may additionally be utilized to protect valuable contents of the vehicle and valuable data stored within the vehicle. Vehicles being protected may be consumer vehicles owned by an individual, commercial vehicles operated by a company, or military vehicles being utilized in a combat setting. The disclosed system and method may be utilized in electronic representation or simulation of the vehicle, devices and systems.

Security within an electronic device or a system including a plurality of electronic devices may be accomplished in a number of ways. Security may prevent theft or unauthorized use of a system. For example, if a vehicle may identify a user attempting to move the vehicle or identify whether a user is on an approved list of users, unauthorized users may be prevented from causing the vehicle to move or invoke equipment integrated with the system.

Security may be additionally or alternatively utilized to enable limited or specific use of a system. For example, a vehicle may be approved for a particular mission or geo-fenced, for example, enabling a delivery driver to travel from delivery waypoint to delivery waypoint, but preventing the user from straying from an approved delivery route. If the driver strays from the approved route, a supervisor may be notified, automated warnings may be issued to the driver, autonomous driving of the vehicle may be engaged to return the vehicle to the approved route, devices or systems on the vehicle may be selectively governed or deactivated (for example, limiting a speed of the vehicle to not exceed a setpoint or a door providing access to a cargo area may be locked), the vehicle may be commanded to pull over to a side of the road and there remain stationary, or other reactive measures may be taken.

Selective permissions may be granted to use the system based upon operational context. Operational context analysis may utilize a plurality of sources of information to determine a context to determined data. Operation of a vehicle by a user may be either inappropriate, malicious, or perfectly normal depending upon the context of the operation. For example, unexpectedly opening a cargo area of a truck may be inappropriate and indicative of potential theft under some circumstances, but a context including a routine check by a law enforcement officer may render the actions normal and acceptable. The disclosed system and method enable selective permission or authorization and selective removal of permission or deauthorization based upon analysis of operational context.

A system providing selective permissions to a plurality of vehicles may operate with data available collected by or regarding the plurality of vehicles. For example, operational context analysis may cross-reference a vehicle with itself, other vehicles taking part of a mission or across related missions. Operational context analysis may examine identity of users, systems involved to process data, events, and actions or performance to dynamically determine required minimum capabilities and required access controls to perform in relation to the operational context.

The disclosed system and method include operational context analysis to enable/disable module capabilities, entitlements, and authorizations. The disclosed system and method utilize device to cloud and cloud to cloud synchronization. The disclosed system and method provide dynamically adjusted least required entitlements and capabilities for the module to perform a task. The dynamically adjusted least required entitlements and capabilities include proportionality to operational context. The disclosed system and method may include preventive actions such as quarantining or geo-fencing in relation to operational context. Events and context may be used to dynamically determine different outcomes. The disclosed system and method may include cross-validating operational context with other vehicles in the proximity or mission and cross-mission validation. The disclosed system and method may include runtime determination of ranking people, overrides, devices and task allocations. The disclosed system and method may include use of forensic print (metadata of last transaction) to establish authenticity. The disclosed system and method may include event tracking by multiple cloud devices to reduce a likelihood of successful spoofing.

The disclosed system and method may include attention draw cues using a connectivity controller as well as vehicle controls to communicate with the user. The disclosed system and method may include coded and sequenced hints with color, flash, audio, and vibrations.

A connectivity controller is a computerized device that is local to the vehicle being controlled. Exemplary operation of the disclosed system and method is provided. A programmed mission is selected, and activation of the connectivity controller is sought. The connectivity controller packages data including operational context, location, current module mode, and intended transaction. The disclosed system and method may use a local security device to request activation of the connectivity controller by the security cloud.

The security cloud receives messages, holds connection, validates operational context, provides an authorization key and allowed capabilities/authorization. The security cloud selects a mode, releases a response and closes a connection. The security cloud sends a complementary authorization key and releases authorization control to a vehicle services cloud. The vehicle services cloud prepares an application image to configure the connectivity controller to perform the selected mission. An application image may be a computerized file including data and may include the released authorization.

The vehicle service cloud transfers a new module mode, capability changes, and an authorization key to the connectivity controller. In one embodiment, the connectivity controller may be blacked out or quarantined, in which case the vehicle is locked down until cleared by the security cloud. If the connectivity controller is not quarantined or blacked out, the connectivity controller sets the new mode and enables/disables capabilities based upon the application image.

Operation of the vehicle according to the mission begins. The connectivity controller collects data, the data is provided back to the security cloud periodically or as events occur, and the data is analyzed based upon operational context. If the analyzed data warrants new authorizations or deactivations, the vehicle services cloud notifies/enforces the new authorizations or deactivations upon the connectivity controller and the vehicle.

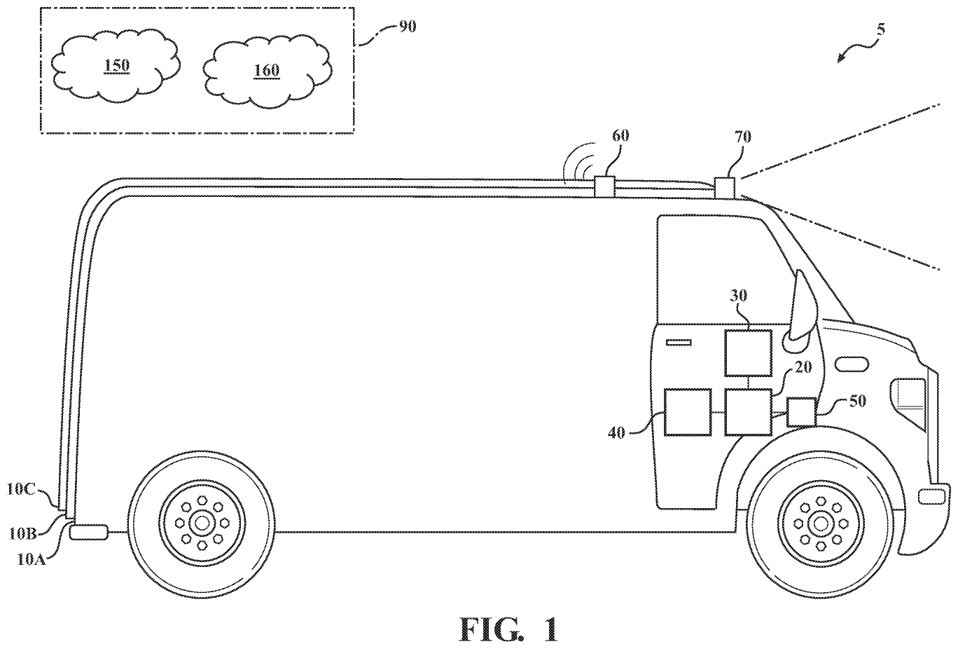

Referring now to the drawings, wherein like reference numbers refer to like features throughout the several views, FIG. 1 schematically illustrates a system 5 including a plurality of devices 10A, 10B, and 10C embodied as a plurality of vehicles. Each of the devices 10A, 10B, and 10C are illustrated including a computerized connectivity controller 20, a vehicle navigation system 30, a vehicle operational system 40, and a vehicle input device 50. The plurality of devices 10A, 10B, and 10C further include a wireless communication system 60 enabling communication with a remote cloud unit 90 through a wireless communication network. The remote cloud unit 90 may represent a plurality of computing resources available through a computerized cloud and is illustrated including a security cloud device 150 and a vehicle services cloud 160. The remote cloud unit 90 may alternatively include one or more remote server devices useful to provide computational support and control. The plurality of devices 10A, 10B, and 10C may include a vehicle sensor system 70 such as a camera device or a light detection and ranging (LIDAR) system useful to enable autonomous or semi-autonomous operation.

The connectivity controller 20 includes a computerized device including a processor and memory, and the connectivity controller 20 enables execution of programmed instructions. The connectivity controller 20 operates the disclosed method on a vehicle level, monitoring operation of the vehicle and selectively providing or denying operation of the vehicle and/or systems upon the vehicle based upon authorizations. The connectively controller 20 may participate in operating processes to determine operational context and to grant or deny permissions based on monitored conditions and the operational context. In another embodiment, operating processes to determine operational context and to grant or deny permissions may be operated remotely within the remote cloud unit 90, with the connectivity controller 20 enacting determinations and issued permissions made by the remote cloud unit 90. In one embodiment, the connectivity controller 20 may normally enact determinations and issued permissions made by the remote cloud unit 90 but may also include programming to make local determinations in the vehicle in a case of poor connectivity. In another embodiment, in a case of poor connectivity with the remote cloud unit 90, the plurality of devices 10A, 10B, and 10C may establish trust in one of the devices 10A, 10B, or 10C, for example, with connectivity in that one vehicle to the remote cloud unit 90 or a supervisor's passcode, and the trust established in that one of the devices 10A, 10B, or 10C may be cascaded to the remaining devices, for example, through challenges and proper responses.

The vehicle navigation system 30 is a computerized device useful to determine and provide a location of the vehicle in relation to a three-dimensional map database. The location of the vehicle may be useful to monitor operation of the vehicle, determine operational context of the vehicle, for example, by enabling comparison of driving of the vehicle to an expected route. In another example, the location of a first of the devices 10A, 10B, or 10C may be compared to locations of the remaining devices 10A, 10B, or 10C to provide context to the first device.

The vehicle operational system 40 includes a device or sub-system of one of the devices 10A, 10B, or 10C which provides a functional output to the respective device 10A, 10B, or 10C. Non-limiting examples of vehicle operational system 40 include a combustion engine, an electric machine of an electric vehicle providing an output torque to propel the vehicle, a steering control system, a braking control system, an autonomous vehicle control system, an audio entertainment system, a telematics system providing connectivity of the vehicle and the user of the vehicle to the Internet, remote server devices, and/or information available through a computing cloud. Each of the devices 10A, 10B, and 10C may include a plurality of vehicle operational systems 40 communicating with and being controlled by the connectivity controller 20. The connectivity controller 20 may include programming to control activation of, limit access to, and/or modulate operation of the vehicle operational systems 40 based upon the disclosed system and method.

The vehicle input device 50 may be a device useful to receive or provide data to the connectivity controller 20. The vehicle input device 50 may include a touch screen device useful to receive inputs from a user of the vehicle. The vehicle input device 50 may include a microphone device useful to receive verbal or audio inputs (for example, to determine context of the driver's intent based upon speech of the driver). The vehicle input device 50 may include a sensor device configured to receive data, such as a door closure sensor, a seat sensor, a fingerprint sensor, a camera device capturing images of a user sitting in a driver's seat (for example, to determine an identify of the driver, to monitor signs of drowsiness of the driver, to determine a level of distractedness in the driver, etc.), a breathalyzer device, an identification card scanner, or other similar device.

The remote cloud unit 90 may include a computerized device or service provided by management of a company owning the devices 10A, 10B, and 10C, a manufacturer of the devices 10A, 10B, and 10C, or a third party providing security for the owner of the devices 10A, 10B, and 10C. In one embodiment, a governmental body may control or provide inputs to the remote cloud unit 90, for example, enabling authorities to route drivers away from a disaster site or to reduce congestion in an area where emergency responders are being active. In one embodiment, an owner/user of a vehicle may consent to governmental or construction crew related control in order to avoid areas with identified back-ups, with identity-based control being used to geo-fence certain users or users with flexible routes away from the back-ups.

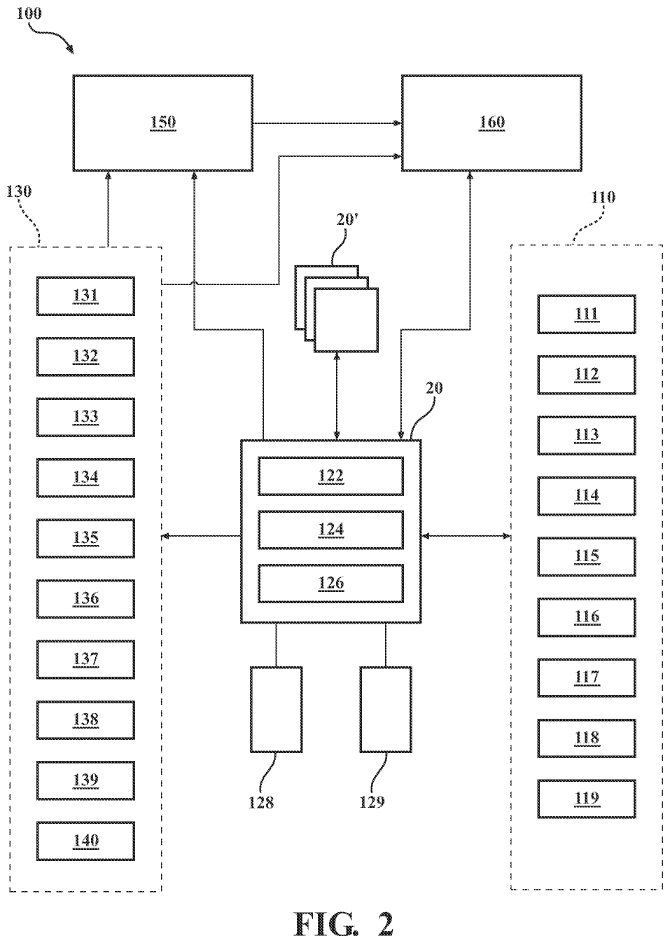

FIG. 2 schematically illustrates a flow 100 of data in the system 5 of FIG. 1. The connectivity controller 20 is illustrated. A plurality of module mode functions 110 are illustrated including software or programming for operation of the connectivity controller 20. Based upon which mode is selected for the connectivity controller 20, function of the vehicle is determined. Module mode function 111 includes a factory mode, wherein the connectivity controller 20 is operated to facilitate secure manufacture of the vehicle, for example, enabling public key infrastructure (PKI) authentication of electronic devices installed to the system 5 of FIG. 1 to establish trust in the hardware and software of the electronic devices. Module mode function 112 includes a post installation or pre-commissioning operation of the connectivity controller 20, including cloud-based confirmation and configuration of electronic devices installed to system 5. Module mode function 113 includes operation of mission-based functions, for example, configuring a particular vehicle for a particular mission, confirming and utilizing vehicle sensors, validating software applications and the data entered thereto, confirming instructions provided to the connectivity controller and/or vehicle navigation system 30, confirming a dormant or mission connected status, etc. Module mode function 114 includes operation of a dormant status function, for example, utilizing the dormant system to collect/store data for store-forward operations in preparation for being instructed to begin a mission. Module mode function 115 includes operation of a connected system function, including active integration, analysis, updates, and other local tasks being provided by the remote cloud unit 90 of FIG. 1. Module mode function 116 includes operation of a blackout mode, for example, enabling operation of the blackout mode to turn off sensors and cease transmission of data. The blackout mode may include operations to preserve, securely store, encrypt, or backup onboard data. Module mode function 117 includes operation of a quarantine mode, for example, responding to anomalies, compromised control, or lost control over aspects of the system 5. The quarantine mode may include restriction of vehicle operational commands or limiting of vehicle operation commands to commands originating from a validated security cloud connection. Module mode function 118 includes operation of a maintenance function, for example, limiting operation of damaged or malfunctioning equipment or decommissioning a vehicle based upon detected malfunctions. Module mode function 119 includes operation of a decommissioned mode, wherein onboard data may be archive imaged and/or destroyed in line with policies.

The connectivity controller 20 is illustrated further including or in communication with a plurality of operating context analyzers 130. The plurality of operating context analyzers 130 are provided as non-limiting examples of context analyses that may be employed according to the disclosed method. The operating context analyzers 130 may be software modules or programming within the connectivity controller 20, within the remote cloud unit 90, or within an additional computerized device. The operating context analyzers 130 are illustrated including software or programming configured for determining operating context for a connected system, device, or vehicle, such as devices 10A, 10B, and 10C of FIG. 1. Operating context analyzer 131 includes a mission analyzer module configured for comparing operation of a device or vehicle to a programmed mission. The operating context analyzer 131 may include software or programming including criteria for validating or failing a device or vehicle as conforming to or as being rogue from the programmed mission. Operating context analyzer 132 includes a cross-mission analyzer. The operating context analyzer 132 may include software or programming to evaluate missions across a plurality of devices or vehicles, for example, devices 10A, 10B, and 10C, and determine an operating context based upon the plurality of devices. In one example, if device 10A includes a mission to deliver packages one through three within region A and device 10B includes a mission to deliver packages four through six within region B, the operating context analyzer 132 may correct programming or command deactivation of device 10B if it moves away from region B toward region A.

Operating context analyzer 133 includes a geo analyzer or geographic analyzer. The operating context analyzer 133 may include software or programming to review a planned route for a vehicle and compare the planned route to various details, such as an actual route followed by the vehicle or tracked traffic backups or emergent conditions. If a planned route is programmed for device 10A along a road that is deemed too icy for travel, the operating context analyzer may utilize geo-fencing to reroute the vehicle to areas with better maintained roads. In another example, if device 10C is determined to have stopped, a vehicle door to have opened, and the device 10C begins driving in a direction inconsistent with a planned route, raising concern of a hijacked vehicle, the operating context analyzer may challenge an identity of the driver, disable the vehicle, or engage autonomous control over the vehicle.

Operating context analyzer 134 includes a network analyzer. The operating context analyzer may include software or programming to evaluate connectivity and integrity of a wireless communication connection between the remote cloud unit 90 of FIG. 1 and the connectivity controller 20. In an example of a lost connection between the remote cloud unit 90 and the connectivity controller 20, the operating context analyzer 134 may include programming to analyze the characteristics of the lost connection and diagnose whether the lost connection is due to geography, weather, infrastructure outage, a traffic anomaly, or a malicious act. Operating context analyzer 135 includes a security analyzer, including software or programming to perform security-related functions. These security-related functions may include establishing an identity of a driver, flagging suspicious behavior of a user or a vehicle, analyzing detected speech within a vehicle, impending and perceived external and insider threats and attacks, and monitoring collision sensors in a vehicle. The operating context analyzer may flag a device or vehicle as being insecure and the data therein as being at risk based upon the security-related functions.

Operating context analyzer 136 includes a data classification analyzer. The operating context analyzer 136 may include software or programming to sort incoming data based upon context of the data. For example, a user instruction to a vehicle to leave a freeway on an unplanned stop with a full gas tank may be classified by the operating context analyzer 136 as a needless diversion, whereas the same user instruction in light of a low fuel indicator being activated may be classified as within normal parameters. Operating context analyzer 137 includes an event analyzer. The operating context analyzer 137 may include software or programming to analyze available information to classify an event. For example, if a vehicle stops abruptly on a freeway, the operating context analyzer 137 may monitor real-time traffic maps, infrastructure camera feeds, in-vehicle sensors, and emergency responder information to determine whether the vehicle has experienced a compromising collision or if the vehicle has stopped because of traffic congestion. Operating context analyzer 138 is a behavior analyzer. The operating context analyzer 138 may include software or programming to evaluate behavior of a vehicle or a user. In one example, if a vehicle weaves onto a shoulder, the context analyzer may analyze camera footage captured by the vehicle to determine whether the vehicle was reasonably avoiding an obstacle such as a blown tire upon the roadway or if the driver is showing signs of drowsiness. Operating context analyzer 139 includes a performance analyzer. The operating context analyzer 139 may include software or programming to evaluate performance of a driver or vehicle as compared to expected performance. For example, an expected time for a vehicle to reach a waypoint may be compared to an actual time, and conforming or non-conforming performance of the driver or vehicle may be determined. Operating context analyzer 140 includes an override analyzer. The operating context analyzer 140 may include software or programming to evaluate an override command, for example, a command to unexpectedly open a cargo area of a vehicle and if the override is in relation to the people's rank and event. The operating context analyzer 140 may utilize available data, for example, camera data, detected speech, and authorization by a supervisor to determine whether the command is valid or non-conforming.

The connectivity controller 20 is illustrated including an operational data collection module 122, a set mode, entitlements, and capabilities module 124, and command, alert, and cue module 126. The operational data collection module 122 includes software or programming to monitor data from available sources in the vehicle, classify, and record the data. The data may include audio, video, voice, image, vehicle and device state, mission system state, cargo quality and quantity, terrain, geography, weather and ambience including structured and unstructured data. The set mode, entitlements, and capabilities module 124 includes software and programming to enact commands to electronic devices of the vehicle including the vehicle operational systems 40 of FIG. 1. Based upon conclusions made regarding an operational context for the vehicle, the set mode, entitlements, and capabilities module 124 may selectively determine an appropriate command to activate, deactivate, provide limited access to, or provide overriding command of the electronic devices of the vehicle. The capabilities module 124, and command, alert, and cue module 126 may include software or programming to execute the determinations made by the set mode, entitlements, and capabilities module 124, for example, cutting power to a non-conforming or counterfeit device, executing a command to keep a cargo door locked based upon suspicious context, or providing full access to an authorized user.

The connectivity controller 20 may further be in communication with and receive data from a plurality of other connectivity controllers 20′ located in other devices, input from an input device 128 from the user of the vehicle, and a security device 129. The input device 128 may include the vehicle input device 50 of FIG. 1 and/or may include inputs through a smart phone device of the user. The security device 129 may be a computerized device, a smart phone, a keypad, a key fob, a black box device, or other device located in the vehicle and providing secure data to the connectivity controller 20.

A security cloud device 150 is illustrated in FIG. 2, which may be operated or include programming stored upon the remote cloud unit 90 of FIG. 1. The security cloud device 150 may generate authorization for devices and users based upon data provided by the operational context analyzers 130 and the connectivity controller 20. The connectivity controller 20, based upon the available authorization data from the security cloud device 150, restricts the capabilities of the vehicle, devices and integrated systems and determines whether to flag a vehicle, a user, an event, a navigational route, etc. as having a suspicious, erroneous, inefficient, or malicious context. The security cloud device 150 may selectively authorize or give permission for a particular level of operation of the vehicle by communication with a vehicle services cloud 160. The vehicle services cloud 160 may include software or programming to perform operational analysis to appropriate authorization or permission of usage and capabilities for the vehicle. The vehicle services cloud 160 may provide commands or classification information to the connectivity controller 20 for enforcement of the determined appropriate authorization or permission of usage and capabilities. The security cloud device 150 and the vehicle services cloud 160 may be operated on separate physical computerized devices and may be at separate physical locations to prevent override by a single operator at a single location. The communication between connectivity controller 20 and security cloud device 150 uses a network different from the network used for communication between security cloud device 150 and vehicle services cloud 160. The communication between connectivity controller 20 and vehicle services cloud 160 uses a network different from the previous networks. If the networks cannot be guaranteed to be unique, the method provides fallback measures to seek out alternative paths of communication between the devices and systems.

The security cloud device and the vehicle services cloud may be segregated physically and electronically. The security cloud device and vehicle services cloud may be configured for communication over a first communication network. The security cloud device and the connectivity controller may be configured for communication over a second communication network distinct from the first communication network. The vehicle services cloud and the connectivity controller may be configured for communication over a third communication network distinct from the first communication network and distinct from the second communication network.

The security cloud device 150 and vehicle services cloud 160 may be validated based in part upon a pair of complementary keys. The pair of complementary keys includes a first factory key stored by the security cloud device and a second factory key stored by the vehicle services cloud 160. The pair of complementary keys provides asymmetric encryption such that the first factory key is solely decryptable with the second factory key. In this way, a message may be sent from the security cloud device 150 to the vehicle services cloud 160 with encrypted data security.

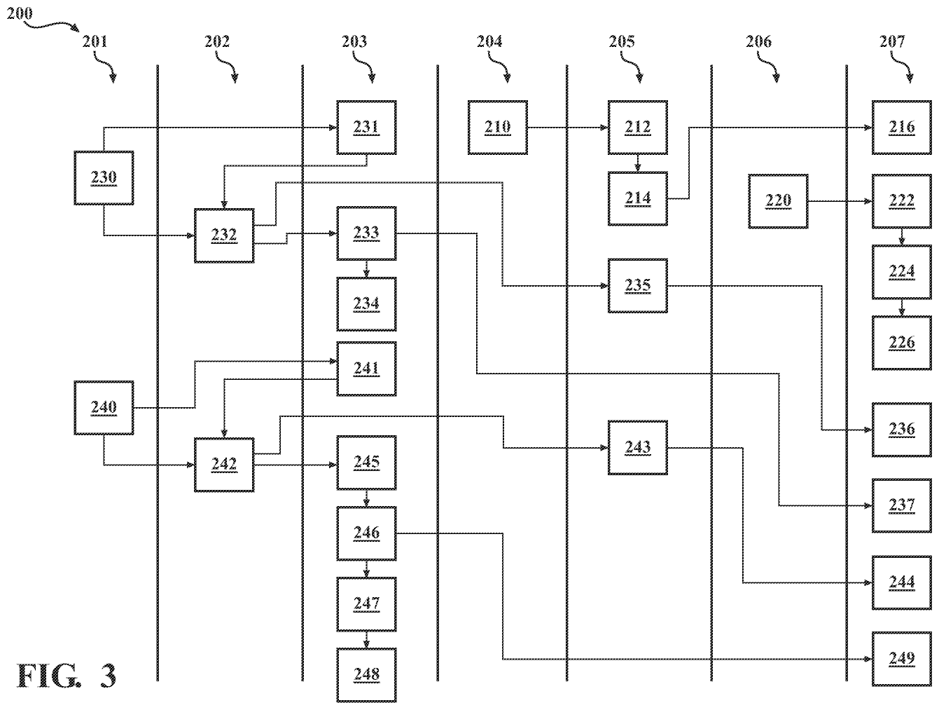

FIG. 3 is a flowchart illustrating method 200 for dynamic authorization, entitlements, and conditional capabilities by operational context. The flowchart illustrates actions taken by seven different actors or systems as vertical columns. In a first vertical column on a left side of the illustration, actions of a mission lead 201 or an individual or device responsible for defining missions for a vehicle are illustrated. In a second vertical column to a right of the mission lead 201, actions of a security device 202 are illustrated. The security device 202 may be the security device 129 of FIG. 2. In a third vertical column to a right of the security device 202, actions of a connectivity module 203 are illustrated. The connectivity module 203 may be the connectivity controller 20 of FIG. 1. In a fourth vertical column to a right of the connectivity module 203, actions of a security administrator 204 controlling or programming the cloud security device 150 of FIG. 2 is illustrated. In a fifth column to a right of the security administrator 204, actions of a security cloud device 205 are illustrated. The security cloud device 205 may be the security cloud device 150 of FIG. 2. In a sixth column to a right of the security cloud device 205, actions of a services lead 206 are illustrated. In a seventh column to a right of the services lead 206, actions of the vehicle services cloud 207 are illustrated. The vehicle services cloud 207 may be the vehicle services cloud 160 of FIG. 2.

In a first operation 210, the security administrator 204 sets-up a mission. Through programming of the security cloud device 205, in operation 212, mission parameters are defined, for example, including defining distances, geographical regions or locations, vehicles, mission system, start time, duration, users involved, and goals. In operation 214, the security cloud device 205 assesses a security readiness. Security readiness may be function of geographic locations/geo-fencing, ranking of people, override flow, module integrity, and cross-mission validation. Authorization constraints and a threat index are determined. In operation 216, the vehicle services cloud 207 receives the authorization constraints and a threat index. Since the mission specific authorization, ranking of people and entitlements are generated at runtime without the need of a permanent storage, unauthorized changes, losing them accidentally or due to a malicious act is eliminated thus avoiding the system compromise.

Operation 220 originates with the services lead 206. In operation 222, the vehicle services cloud 207 sets-up mission parameters, including defining distances, geographical regions or locations, vehicles, mission system, start time, duration, users involved, and goals. In operation 224, the vehicle services cloud 207 determines vehicle mission readiness, for example, including evaluating vehicle configurations, vehicle health, alerts available, for example, related to user identities and conditions, weight restrictions, traffic conditions, etc. In operation 226, the vehicle services cloud 207 packages module applications and configuration commands for the vehicles involved in a mission.

Operation 230 originates with mission preparation by the mission lead 201. In operation 231, the connectivity module 203 provides operational context such as gross weight sensor information, events, geographic information, and forensic print data (such as metadata of a last transaction). In operation 232, the security device 202 requests authentication of a user of a respective vehicle and activates modules based upon proper authentication. In operation 233, the connectivity module 203 activates, sets mode and usage authorities, performs authorization key checks, selectively enables and disables capabilities, and creates an image of corresponding data. In operation 234, the connectivity module configures and saves the image and goes dormant in expectation of the mission being executed. In operation 235, the security cloud device 205 holds a connection with the security device, validates an operational context of the mission, provides an authorization key and a summary of allowed capabilities, authorizations, and modes. The security cloud device 205 releases a response with the described authorization key and summary to the vehicle services cloud 207. In operation 236, the vehicle services cloud receives a complementary authorization key and authorization control over the mission. In operation 237, the vehicle services cloud 207 validates operational context for the mission (for example, geographical and network health information). The vehicle services cloud 207 releases an image with applications for the mission including allowed entitlements by application.

Operation 240 originates with the mission lead 201 with a command to execute the mission. In operation 241, activation of the connectivity controller 20 is prompted. In operation 242, a query is made with the security device 202 to activate the vehicle or device and provide proof of authentication. In operation 243, a connection between the security cloud device 205 and the security device 202 are held and the proof of identification entered into the security device 202 is provided to the security cloud device 205. The security cloud device 205 validates the proof of identification and validates use of the vehicle in the context with the other connected cross-mission vehicles. The security cloud device 205 validates the intended transaction to execute the mission, generates a new mode, generates a transaction authorization key, determines least required capabilities useful to complete the mission, computes a threat index, releases a response and closes the connection. In operation 244, the vehicle services cloud 207 receives a complementary authorization key and receives authorization and the threat index from the security cloud device 205. In operation 245, the connectivity module 203 is activated, a determined mode is set, and the connectivity module 203 provides commands to electronic devices of the vehicle, enacting enablement and disablement commands and capabilities. Operation 246 occurs after the vehicle has started upon its mission, wherein the connectivity module 203 iteratively provides operational context (for example, including a distance traveled and data classifications), events, geographical information, and forensic print information. While the vehicle is on its mission, in operation 249, the vehicle services cloud 207 holds a connection with the connectivity module 203, enforces authorization commands, validates provided data with the vehicle and other vehicles in context and cross-mission, validates data based upon the intended transaction, processes the data, and generates a new mode and commands to perform. The vehicle services cloud 207 releases a response and closes the connection. In operation 247, new modes and newly created commands are executed. In operation 248, the vehicle completes the mission and the method 200 ends.

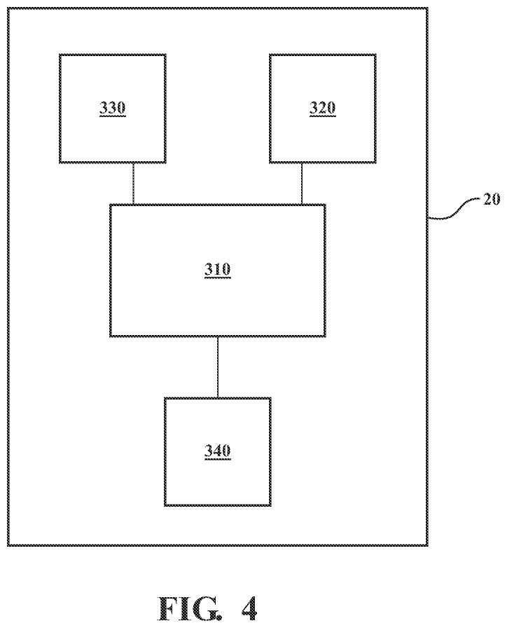

FIG. 4 schematically illustrates the connectivity controller 20 of FIG. 1. The computerized connectivity controller 20 includes a computerized processing device 310, a communications device 320, an input output coordination device 330, and a memory storage device 340. It is noted that the computerized connectivity controller 20 may include other components and some of the components are not present in some embodiments.

The processing device 310 may include memory, e.g., read only memory (ROM) and random-access memory (RAM), storing processor-executable instructions and one or more processors that execute the processor-executable instructions. In embodiments where the processing device 310 includes two or more processors, the processors may operate in a parallel or distributed manner. The processing device 310 may execute the operating system of the connectivity controller 20. Processing device 310 may include one or more modules executing programmed code or computerized processes or methods including executable steps. Illustrated modules may include a single physical device or functionality spanning multiple physical devices. The processing device 310 executes the programming of the operational data collection module 122, the set mode, entitlements, and capabilities module 124, and the command, alert, and cue module 126 of FIG. 2. In one embodiment, the connectivity controller 20 or portions thereof may include electronic versions of the processing device.

The communications device 320 may include a communications/data connection with a bus device configured to transfer data to different components of the system and may include one or more wireless transceivers for performing wireless communication.

The input output coordination device 330 includes hardware and/or software configured to enable the processing device 310 to receive and/or exchange data with onboard sensors of the host vehicle and to provide control of switches, modules, and processes throughout the vehicle based upon determinations made within processing device 310.

The memory storage device 340 is a device that stores data generated or received by the connectivity controller 20. The memory storage device 340 may include, but is not limited to, a hard disc drive, an optical disc drive, and/or a flash memory drive.

The computerized connectivity controller 20 is provided as an exemplary computerized device capable of executing programmed code to operate the disclosed process. A number of different embodiments of the connectivity controller 20 and modules operable therein are envisioned, and the disclosure is not intended to be limited to examples provided herein.

While the best modes for carrying out the disclosure have been described in detail, those familiar with the art to which this disclosure relates will recognize various alternative designs and embodiments for practicing the disclosure within the scope of the appended claims.

What is claimed is:

1. A system for dynamic authorization, entitlements, and conditional capabilities by operational context to authorize operating a vehicle and integrated systems in conjunction with a remote cloud unit, the system comprising:
the vehicle including:
a vehicle operational system providing a functional output to the vehicle; and
a computerized connectivity controller, including programming to:
collect data from a plurality of sources related to operation of the vehicle;
provide the data to a plurality of operating context analyzers to generate an operating context to the data;
receive an authorization to operate the vehicle operational system; and
selectively enable operation of the vehicle operational system based upon the authorization;
the plurality of operating context analyzers, including programming to determine the operating context to the data based upon the data from the plurality of sources; and
the remote cloud unit, including programming to:
selectively generate the authorization based upon the data and the operating context to the data; and
release the authorization to the computerized connectivity controller.

2. The system of claim 1, wherein the data related to operation of the vehicle includes data describing a mission selected for the vehicle, data describing other vehicles on the mission, data describing other missions, an identity of a user of the vehicle, a capability of the vehicle to accomplish the mission, an event, and an action by the user.

3. The system of claim 2, wherein the capability of the vehicle to accomplish the mission includes data related to a distance to be driven, geographic information, forensic print and a configuration and state of the vehicle.

4. The system of claim 1, wherein the plurality of operating context analyzers is operated within the computerized connectivity controller.

5. The system of claim 1, wherein the remote cloud unit includes:
a security cloud device configured for selectively generating the authorization; and
a vehicle services cloud configured for:
generating an application image including the authorization; and
releasing the application image to the computerized connectivity controller.

6. The system of claim 5, wherein the security cloud device and the vehicle services cloud are segregated physically and electronically;
wherein the security cloud device and vehicle services cloud are configured for communication over a first communication network;
wherein the security cloud device and the connectivity controller are configured for communication over a second communication network distinct from the first communication network; and
wherein the vehicle services cloud and the connectivity controller are configured for communication over a third communication network distinct from the first communication network and distinct from the second communication network.

7. The system of claim 5, wherein communication between the security cloud device and the vehicle services cloud is encrypted with a complementary pair of authorization keys.

8. The system of claim 5, wherein the security cloud device is further configured for determining a least required capability of the vehicle to accomplish a mission; and
wherein the computerized connectivity controller selectively enabling operation of the vehicle operational system is further based upon the least required capability.

9. A system for dynamic authorization, entitlements, and conditional capabilities by operational context to authorize operating a vehicle and integrated systems in conjunction with a remote cloud unit, the system comprising:
the vehicle including:
a vehicle operational system providing a functional output to the vehicle;
a computerized connectivity controller, including programming to:
collect data from a plurality of sources related to operation of the vehicle;
provide the data to a plurality of operating context analyzers to generate an operating context to the data;
receive an application image including an authorization to operate the vehicle operational system; and
selectively enable operation of the vehicle operational system based upon the authorization; and
the plurality of operating context analyzers, including programming to determine the operating context to the data based upon the data from the plurality of sources; and
the remote cloud unit, including:
a security cloud device configured for selectively generating the authorization based upon the data and the operating context to the data; and
a vehicle services cloud configured for:
generating the application image including the authorization; and
releasing the application image to the computerized connectivity controller.

10. The system of claim 9, wherein the security cloud device and the vehicle services cloud are segregated physically and electronically;
wherein the security cloud device and vehicle services cloud are configured for communication over a first communication network;
wherein the security cloud device and the connectivity controller are configured for communication over a second communication network distinct from the first communication network; and
wherein the vehicle services cloud and the connectivity controller are configured for communication over a third communication network distinct from the first communication network and distinct from the second communication network.

11. The system of claim 9, wherein communication between the security cloud device and the vehicle services cloud is encrypted with a complementary pair of authorization keys.

12. The system of claim 9, wherein the security cloud device is further configured for determining a least required capability of the vehicle to accomplish a mission; and
wherein the computerized connectivity controller selectively enabling operation of the vehicle operational system is further based upon the least required capability.

13. A method for dynamic authorization, entitlements, and conditional capabilities by operational context to authorize operating a vehicle and integrated systems in conjunction with a remote cloud unit, the method comprising:
operating within the vehicle a vehicle operational system providing a functional output to the vehicle;
within a computerized processor within the vehicle:
collecting data from a plurality of sources related to operation of the vehicle;
providing the data to a plurality of operating context analyzers to generate an operating context to the data;
receiving an authorization to operate the vehicle operational system; and
selectively enabling operation of the vehicle operational system based upon the authorization;
operating the plurality of operating context analyzers, including programming to determine the operating context to the data based upon the data from the plurality of sources; and
within the remote cloud unit,
selectively generating the authorization based upon the data and the operating context to the data; and
releasing the authorization to the computerized processor within the vehicle.

14. The method of claim 13, wherein the data related to operation of the vehicle includes data describing a mission selected for the vehicle, data describing other vehicles on the mission, an identity of a user of the vehicle, a capability of the vehicle to accomplish the mission, an event, and an action by the user.

15. The method of claim 14, wherein the capability of the vehicle to accomplish the mission includes data related to a distance to be driven, geographic information, forensic print, and a configuration and state of the vehicle.

16. The method of claim 13, wherein the plurality of operating context analyzers is operated within the computerized processor within the vehicle.

17. The method of claim 13, wherein selectively generating the authorization within the remote cloud unit includes selectively generating the authorization within a security cloud device; and
wherein releasing the authorization within the remote cloud unit includes:
generating an application image including the authorization with a vehicle services cloud; and
releasing the application image to the computerized processor within the vehicle.

18. The method of claim 17, wherein the security cloud device and the vehicle services cloud are segregated physically and electronically; and
further comprising:
communicating between the security cloud device and vehicle services cloud over a first communication network;
communicating between the security cloud device and the computerized processor within the vehicle over a second communication network distinct from the first communication network; and
communicating between the vehicle services cloud and the computerized processor within the vehicle over a third communication network distinct from the first communication network and distinct from the second communication network.

19. The method of claim 17, further comprising encrypting communication between the security cloud device and the vehicle services cloud with a complementary pair of authorization keys.

20. The method of claim 17, further comprising determining a least required capability of the vehicle to accomplish a mission; and
wherein selectively enabling operation of the vehicle operational system is further based upon the least required capability.
